(19) United States
(12) Patent Application Publication
(10) Pub. No.: US 2023/0336632 A1
(43) Pub. Date: Oct. 19, 2023

(54) SERVER APPARATUS, ONLINE CONFERENCE SYSTEM, BUSINESS CARD EXCHANGE METHOD, AND COMPUTER READABLE STORAGE MEDIUM

(71) Applicant: NEC Corporation, Minato-ku, Tokyo (JP)

(72) Inventor: Tatsuki AKUTSU, Tokyo (JP)

(73) Assignee: NEC Corporation, Minato-ku, Tokyo (JP)

(21) Appl. No.: 18/014,446

(22) PCT Filed: Jul. 8, 2020
(86) PCT No.: PCT/JP2020/026695

§ 371 Date: Jan. 4, 2023

(51) Int. Cl. H04L 67/306; H04L 65/403; G06Q 10/107

(52) U.S. Cl. CPC H04L 67/306; H04L 65/403; G06Q 10/107

(57) ABSTRACT

A server apparatus that enables business card exchange online is provided. The server apparatus includes an acquisition unit and a business card exchange control unit. The acquisition unit acquires profile information of each of a plurality of users. The business card exchange control unit generates a digital business card for a first user and a second user who participate in the same online conference among the plurality of users, based on profile information of each of the first and second users. The business card exchange control unit exchanges the generated digital business cards between the first and second users.

### TECHNICAL FIELD

The present invention relates to a server apparatus, an online conference system, a business card exchange method, and a computer readable storage medium.

### BACKGROUND ART

In recent years, with development of network technology and information processing technology, an online conference in which conference rooms in remote locations are connected by a network has been actively conducted.

For example, Patent Literature 1 describes that a user's operational burden, such as display of personal information of attendees during a conference, is reduced, and therefore, the conference can be operated smoothly and efficiently.

### CITATION LIST

### Patent Literature

[Patent Literature 1] Japanese Unexamined Patent Application Publication No. H06-152765

### SUMMARY OF INVENTION

### Technical Problem

As described above, online conferences have been actively held. In a normal conference, business card exchange between parties concerned is performed when participants in the first face-to-face meeting attend the conference. The participant can acquire information about the person from an acquired business card.

However, business cards cannot be exchanged in an online conference conducted by connecting remote locations by a network, and a participant cannot acquire information about a person in the first face-to-face meeting.

A main object of the present invention is to provide a server apparatus, an online conference system, a business card exchange method, and a computer readable storage medium that contribute to enabling business card exchange online.

### Solution to Problem

According to a first aspect of the present invention, there is provided a server apparatus including: an acquisition unit configured to acquire profile information of each of a plurality of users; and a business card exchange control unit configured to generate a digital business card for a first user and a second user who participate in the same online conference among the plurality of users, based on profile information of each of the first and second users, and configured to exchange the generated digital business cards between the first and second users.

According to a second aspect of the present invention, there is provided an online conference system including: a first terminal to be used by a first user; a second terminal to be used by a second user; and a server apparatus being connected to the first and second terminals, wherein the server apparatus includes an acquisition unit configured to acquire profile information of each of a plurality of users, and a business card exchange control unit configured to generate a digital business card for the first user and the second user who participate in the same online conference among the plurality of users, based on profile information of each of the first and second users, and configured to transmit a digital business card for the first user to the second terminal and transmit a digital business card for the second user to the first terminal.

According to a third aspect of the present invention, there is provided a business card exchange method including, by a server apparatus: acquiring profile information of each of a plurality of users; generating a digital business card for a first user and a second user who participate in the same online conference among the plurality of users, based on profile information of each of the first and second users; and exchanging the generated digital business cards between the first and second users.

According to a fourth aspect of the present invention, there is provided a computer readable storage medium storing a program for causing a computer mounted on a server apparatus to execute: processing of acquiring profile information of each of a plurality of users; processing of generating a digital business card for a first user and a second user who participate in the same online conference among the plurality of users, based on profile information of each of the first and second users; and processing of exchanging the generated digital business cards between the first and second users.

### Advantageous Effects of Invention

According to aspects of the present invention, a server apparatus, an online conference system, a business card exchange method, and a computer readable storage medium are provided that contribute to enabling business card exchange online. Note that an effect of the present invention is not limited to the above. According to the present invention, another effect may be achieved instead of or in conjunction with the effect.

### BRIEF DESCRIPTION OF DRAWINGS

FIG. 1 is a diagram for explaining a summary of an example embodiment;

FIG. 2 is a diagram illustrating an example of an overview configuration of an online conference system according to a first example embodiment;

FIG. 3 is a diagram illustrating an example of display of a terminal according to the first example embodiment;

FIG. 4 is a diagram for explaining an operation overview of the online conference system according to the first example embodiment;

FIG. 5 is a diagram for explaining an operation overview of the online conference system according to the first example embodiment;

FIG. 6 is a diagram for explaining an operation overview of the online conference system according to the first example embodiment;

FIG. 7 is a diagram illustrating an example of a processing configuration of a server apparatus according to the first example embodiment;

FIG. 8 is a diagram illustrating an example of a processing configuration of a user registration unit according to the first example embodiment;

FIG. 9 is a diagram for explaining an operation of an information acquisition unit according to the first example embodiment;

FIG. 10 is a diagram illustrating an example of a user information database according to the first example embodiment;

FIG. 11 is a diagram illustrating an example of a participant list according to the first example embodiment;

FIG. 12A is a diagram illustrating an example of conference basic information according to the first example embodiment;

FIG. 12B is a diagram illustrating an example of conference basic information according to the first example embodiment;

FIG. 13 is a diagram for explaining the operation of a business card exchange control unit according to the first example embodiment;

FIG. 14 is a diagram illustrating an example of a processing configuration of the terminal according to the first example embodiment;

FIG. 15 is a diagram illustrating an example of display of the terminal according to the first example embodiment;

FIG. 16 is a diagram illustrating an example of display of the terminal according to the first example embodiment;

FIG. 17 is a diagram illustrating an example of a digital business card database according to the first example embodiment;

FIG. 18 is a sequence diagram illustrating an example of an operation of the online conference system according to the first example embodiment;

FIG. 19 is a diagram for explaining an operation of a user registration unit according to a second example embodiment;

FIG. 20 is a diagram illustrating an example of display of a terminal according to the second example embodiment;

FIG. 21 is a diagram illustrating an example of a schematic configuration of an online conference system according to a third example embodiment;

FIG. 22 is a diagram illustrating an example of a processing configuration of a database server according to the third example embodiment;

FIG. 23 is a diagram illustrating an example of a processing configuration of a terminal according to the third example embodiment;

FIG. 24 is a diagram illustrating an example of a digital business card database according to the third example embodiment;

FIG. 25 is a diagram illustrating an example of a hardware configuration of a server apparatus;

FIG. 26 is a diagram illustrating an example of display of a terminal according to a modified example of the present disclosure; and

FIG. 27 is a diagram illustrating an example of display of a terminal according to a modified example of the present disclosure.

### EXAMPLE EMBODIMENT

First, a summary of an example embodiment will be explained. Note that reference numerals in the drawings added to this summary are added for convenience sake to each element as an example for helping understanding, and description of this summary is not intended to be limiting in any way. In addition, unless otherwise specified, blocks described in each drawing represent not a configuration of a hardware unit but a configuration of a functional unit. Connection lines between blocks in each figure include both bidirectional and unidirectional directions. A one-way arrow schematically indicates a flow of a main signal (data), and does not exclude the bidirectional direction. In the present specification and the drawings, elements that can be similarly explained may be denoted by the same reference numerals, and redundant description may be omitted.

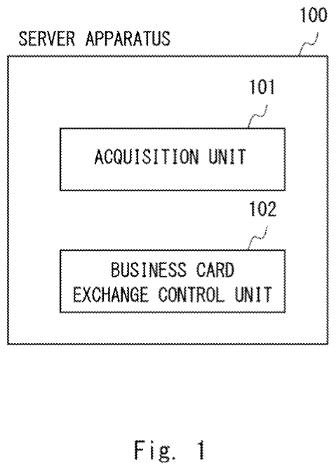

A server apparatus 100 according to an example embodiment includes an acquisition unit 101 and a business card exchange control unit 102 (see FIG. 1). The acquisition unit 101 acquires profile information of each of a plurality of users. The business card exchange control unit 102 generates a digital business card for the first user and the second user who participate in the same online conference among the plurality of users, based on profile information of each of the first and second users. The business card exchange control unit 102 exchanges the generated digital business cards between the first and second users.

Participants in the online conference enter their own profile into the server apparatus 20 in advance. The server apparatus 100 generates a digital business card from a profile being input in advance when a request for business card exchange is acquired from the online conference participant. The generated digital business card is distributed to the business card exchange party. As described above, the server apparatus 100 of the present disclosure enables business card exchange online. In particular, since the server apparatus 100 generates a digital business card from the profile information registered in advance, it enables flexible correspondence such as changing contents to be described depending on the business card exchange partner.

Specific example embodiments will be explained in more detail below with reference to the drawings.

### First Example Embodiment

A first example embodiment will be explained in more detail with reference to the drawings.

### [System Configuration]

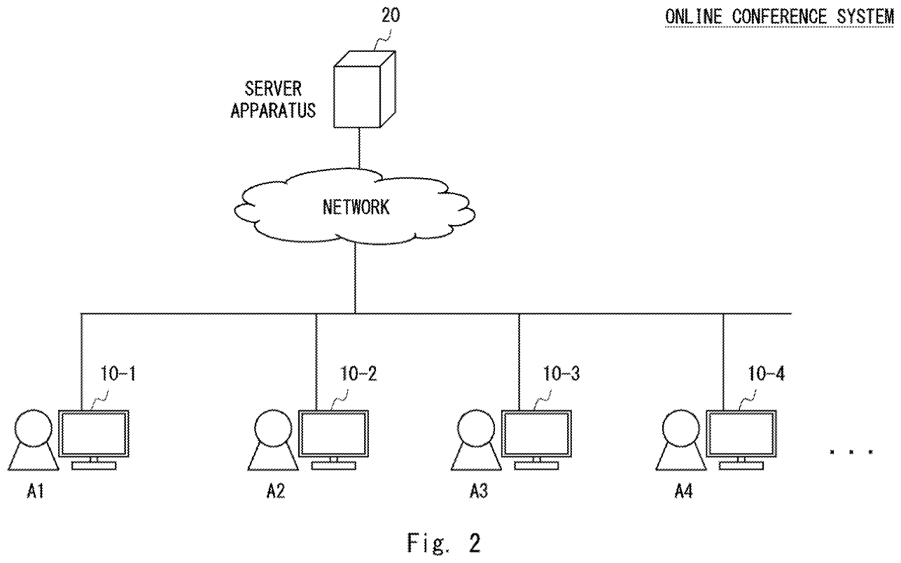

FIG. 2 is a diagram illustrating an example of an overview configuration of an online conference system according to the first example embodiment. As illustrated in FIG. 2, the online conference system includes a plurality of terminals 10-1 to 10-4 and a server apparatus 20.

In the following explanation, when there is no particular reason for distinguishing between the terminals 10-1 to 10-4, it is simply referred to as “terminal 10”. The configuration illustrated in FIG. 2 is an example, and is not intended to limit the configuration of an online conference system (video conference system) or the like. The online conference system may include at least two or more terminals 10.

Each of the plurality of terminals 10 and the server apparatus 20 are connected by a wired or wireless communication means, and are configured to be able to communicate with each other. The server apparatus 20 may be a server installed in a company or the like holding an online conference, or may be installed on a network (cloud).

A user participates in the online conference by using the terminal 10. Examples of the terminal 10 include a mobile terminal apparatus such as a smartphone, a mobile phone, and a tablet, a computer (a personal computer, a notebook computer), and the like. The terminal 10 includes a camera for capturing an image of a user, a microphone for acquiring a voice of the user, and the like.

The server apparatus 20 is an apparatus that achieves an online conference. The server apparatus 20 transmits audio data and image data acquired from the terminal 10 to another terminal 10. Another terminal 10 outputs the audio data and the image data acquired from the server apparatus 20. Note that an existing technology can be used to achieve the online conference system by the server apparatus 20. Therefore, in the following explanation, explanation of achievement and implementation of the online conference system will be omitted.

The online conference system illustrated in FIG. 2 has a function of providing a participant with simple information of other participants (information for introducing the participants themselves; hereinafter, referred to as participant basic information or basic information). Examples of the participant basic information include a face image, a name, an affiliation company (affiliation department), a title of the participant, and the like.

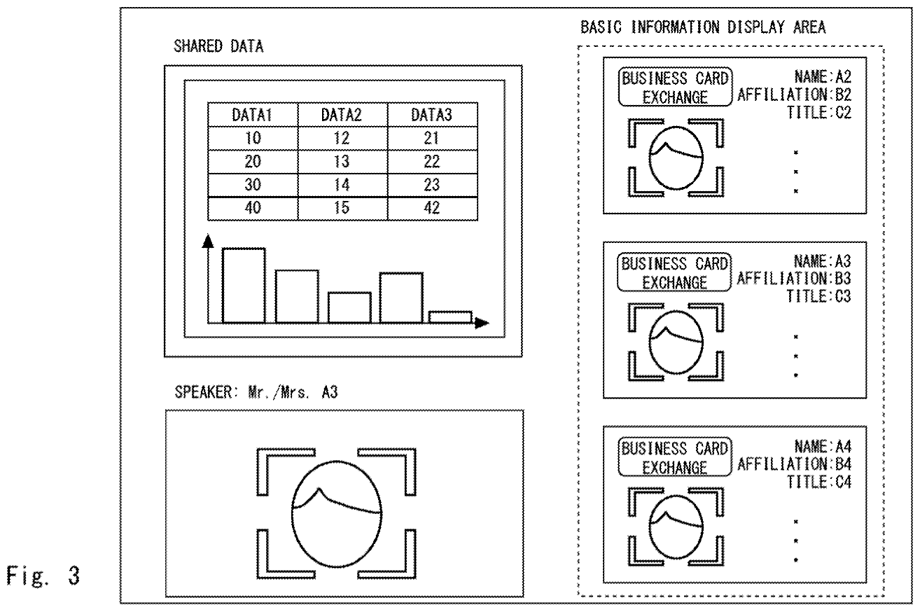

During the online conference, the terminals 10 to be used by the participants are displayed as illustrated in FIG. 3. As illustrated in FIG. 3, the terminal 10 provides an area (basic information display area) for displaying basic information about other participants on all or a part of the screen, and displays the basic information in the area. In an area other than the basic information display area, data shared by each participant of the online conference and information about a speaker may be displayed.

For example, as illustrated in FIG. 2, when a user A1 uses the terminal 10-1, the terminal 10-1 performs display as illustrated in FIG. 3. As illustrated in FIG. 3, basic information regarding the user A1 who is a user of the terminal 10-1 is not displayed on the terminal 10-1. This is because it is not necessary to introduce the user himself/herself. However, it is needless to say that basic information about the user of the terminal 10 may be displayed on the terminal 10.

The participants of the conference can acquire basic information of other participants (overview information of other participants) by confirming the basic information displayed on the terminal 10 to be used.

The online conference system illustrated in FIG. 2 has a function of achieving business card exchange online in addition to providing the above participant basic information.

As illustrated in FIG. 3, in the basic information display area, a “business card exchange” button is prepared in response to each participant. The participant refers to the basic information and determines whether another participant is a participant in the first face-to-face meeting or a known participant. The participant presses the “business card exchange” button of a participant with whom he/she wants to exchange a business card when a participant in the first face-to-face meeting and with whom he/she desires to exchange a business card is included among the participants.

When the business card exchange button is pressed, business card exchange is performed between business card exchange parties (a business card exchange requester, a participant who is requested to exchange business cards; a business card exchange request recipient) via the server apparatus 20. More specifically, the server apparatus 20 generates a “digital business card” of each of the business card exchange requester and the business card exchange request recipient, and transmits the generated digital business card to the terminal 10 to be used by the business card exchange partner.

The terminal 10 stores the acquired digital business card.

The display screen illustrated in FIG. 3 is an example, and it is needless to say that the display screen is not intended to limit the contents, layout, and the like to be displayed. For example, there may not be an area in which shared data are displayed or an area in which details of the speaker are displayed. In addition, in a case where a size of the basic information display area is limited and the basic information of each participant cannot be displayed at once, a button for switching the information to be displayed (a next button or a previous button) or a button for scrolling the screen may be displayed. Further, the basic information display area does not need to be always displayed, and a button, an icon, and the like for calling up the basic information display area may be prepared.

### [Operation Overview]

Next, an operation overview of the online conference system according to the first example embodiment will be explained with reference to the drawings.

### <Pre-Registration>

In order to participate in the online conference by the server apparatus 20, a system user (a user who is scheduled to participate in the online conference) needs to perform pre-registration. Hereinafter, the pre-registration of the user will be explained.

The user registers his/her own profile in the system. Specifically, the user inputs biometric information (e.g., a face image) and attribute information (e.g., information such as a name, a work company, an employee number, a work location, a department to which the user is affiliated, a title, a telephone number, and an e-mail address) as “profile information” to the server apparatus 20. As the attribute information, in addition to the above-described information, a job history, an educational background, a background, a possession qualification, a one-word message, and the like may be registered in the system.

For convenience of explanation, the biometric information and the attribute information of the user are described separately, but they are not different from each other in that both of them are information (personal information) indicating the attribute of the user. Namely, the profile information registered in the system includes a plurality of items (e.g., a face image, a name, an affiliation, and the like) related to the attribute of each user.

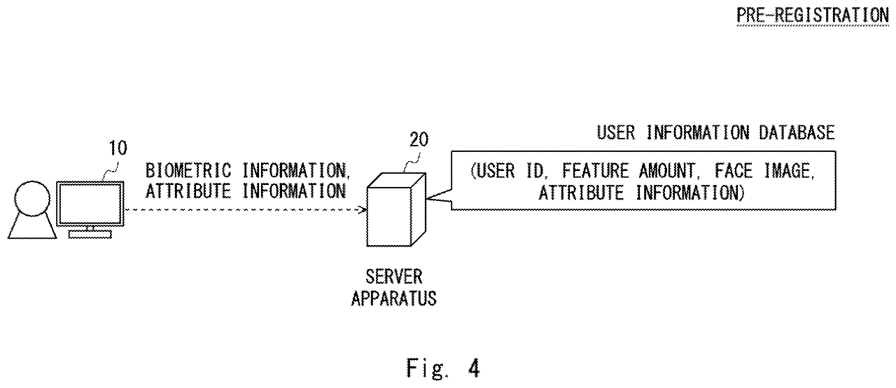

Any method can be used to input the profile information. For example, as illustrated in FIG. 4, the user may register profile information (biometric information and attribute information) in the server apparatus 20 by using the terminal 10. Alternatively, the user may input information required for the server apparatus 20 by using an external storage apparatus such as a Universal Serial Bus (USB) in which the information is stored.

The server apparatus 20 updates database for managing the system user by using the acquired profile information (biometric information and attribute information). Although details regarding the update of the database will be described later, the server apparatus 20 updates the database by the overview operation as follows. In the following explanation, a database for managing users who use the system of the present disclosure will be referred to as a “user information database”.

When the person associated to the acquired profile information is a new user who is not registered in the user information database, the server apparatus 20 assigns an Identifier (ID) to the user. Thereafter, the server apparatus 20 generates a feature amount that characterizes the acquired face image.

The server apparatus 20 adds an entry including a user ID assigned to a new user, a feature amount generated from the face image, a face image of the user, attribute information, and the like to the user information database. When the server apparatus 20 registers the profile information, participants in the conference can use the online conference system illustrated in FIG. 2.

### <Conference Start>

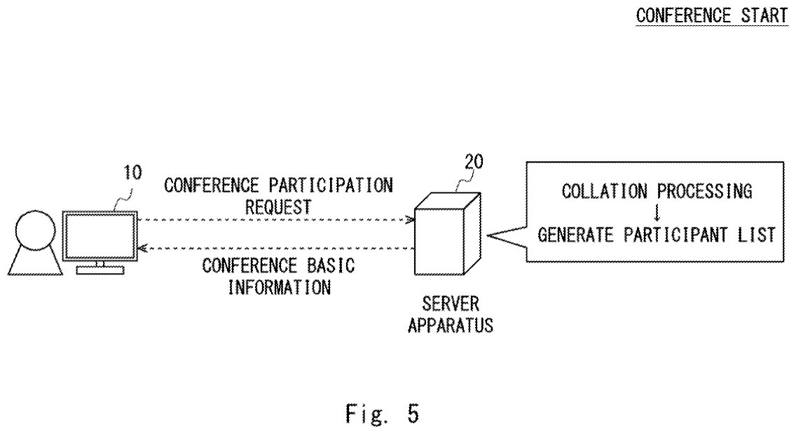

When starting an online conference, the terminal 10 acquires a face image (biometric information) of the conference participant, and transmits a “conference participation request” including the acquired face image to the server apparatus 20 (see FIG. 5). The server apparatus 20 executes collation processing by using the face image extracted from the conference participation request, and identifies a user ID of the person who desires to participate in the conference from the user information database.

The server apparatus 20 generates a participant list by listing the identified user IDs. The participant list is information in which the user ID of the participant is associated with an ID (terminal ID) of the terminal 10 to be used by the participant. The server apparatus 20 generates a participant list for each conference.

After generating the participant list, the server apparatus 20 transmits “conference basic information” to each terminal 10 to be used by the participant participating in the conference. The conference basic information includes the participant basic information associated to the user ID of the participant.

The terminal 10 stores the acquired conference basic information. The terminal 10 can display the screen (the screen of the basic information display area) as illustrated in FIG. 3 by using the conference basic information.

### <Digital Business Card Exchange>

A participant who desires to exchange business cards online presses the “business card exchange” button displayed on the terminal 10.

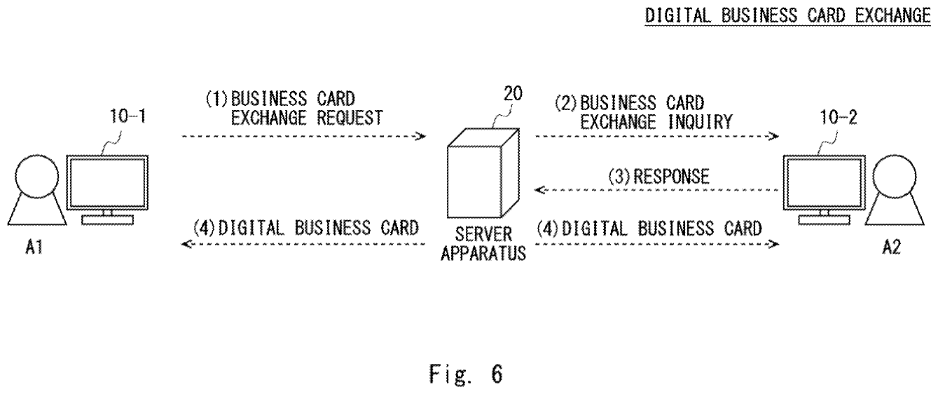

When the pressing of the business card exchange button is detected, the terminal 10 transmits a digital business card exchange request (also referred to simply as a business card exchange request) to the server apparatus 20 (see FIG. 6). The digital business card exchange request includes a user ID of a user who desires to exchange a business card (hereinafter, referred to as “requester ID”) and a user ID of a user who is requested to exchange a business card (hereinafter, referred to as “request recipient ID”).

For example, the example of FIG. 3 is considered. FIG. 3 is a screen displayed on the terminal 10-1 to be used by the user A1. When the user A1 desires to exchange a business card with a user A2, the user A1 becomes a business card exchange requester, and the user A2 becomes a business card exchange request recipient. The terminal 10-1 sets the user ID of the user A1 to “requester ID” and a user ID of the user A2 to “request recipient ID”, and transmits a digital business card exchange request to the server apparatus 20.

The server apparatus 20 extracts the request recipient ID from the digital business card exchange request, and identifies the terminal 10 to be used by the business card exchange request recipient by referring to the participant list. In the examples of FIGS. 3 and 6, a terminal 10-2 to be used by the user A2 is identified.

The server apparatus 20 transmits a digital business card exchange inquiry (also simply referred to as a business card exchange inquiry) to the identified terminal 10 (see FIG. 6). The inquiry is an inquiry as to whether the business card exchange request recipient accepts the business card exchange. The digital business card exchange inquiry includes the user ID (requester ID) of the business card exchange requester.

The terminal 10 acquires user's intention to the inquiry, and transmits the result (business card exchange acceptance, business card exchange rejection) to the server apparatus 20. When the business card exchange is accepted, the terminal 10 transmits an acknowledgement to the server apparatus 20. When the business card exchange is rejected, the terminal 10 transmits a negative acknowledgement to the server apparatus 20.

When the business card exchange is accepted, the server apparatus 20 generates a digital business card of the business card exchange party (the user A1 and the user A2 in the example of FIG. 6). The server apparatus 20 transmits the generated digital business card to the destination.

When the business card exchange is rejected, the server apparatus 20 notifies the business card exchange requester (in the example of FIG. 6, the user A1; the terminal 10-1) of this fact.

The terminal 10 stores the digital business card acquired from the server apparatus 20.

Note that various methods can be used for generating the digital business card for the user. For example, the server apparatus 20 may generate a digital business card by using all or a part of profile information of the pre-registered user. For example, the server apparatus 20 may generate a digital business card in such a way as to include more detailed information (more information) than participant basic information provided to each participant at the start of the conference.

For example, when the participant basic information includes “a face image, a name, a company to which one is affiliated, and a title”, the server apparatus 20 may generate a digital business card including a telephone number, an e-mail address, a job history, an educational background, a background, a possession qualification, and the like in addition to the information.

Next, details of each apparatus included in the online conference system according to the first example embodiment will be explained.

### [Server Apparatus]

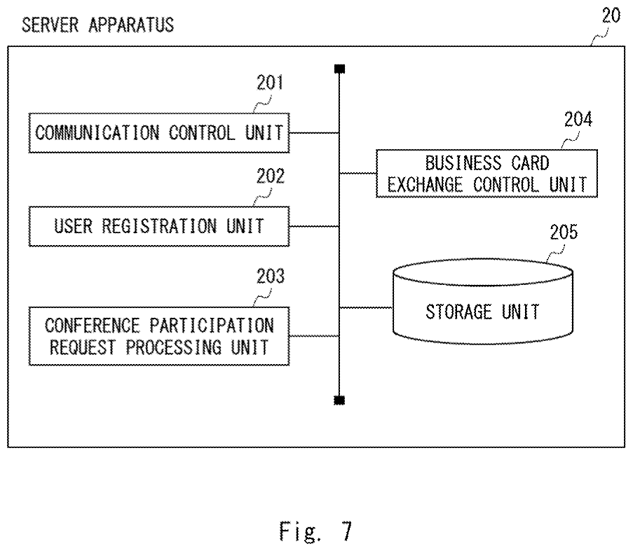

FIG. 7 is a diagram illustrating an example of a processing configuration (processing module) of the server apparatus 20 according to the first example embodiment. Referring to FIG. 7, the server apparatus 20 includes a communication control unit 201, a user registration unit 202, a conference participation request processing unit 203, a business card exchange control unit 204, and a storage unit 205.

The communication control unit 201 is a means for controlling communication with other apparatuses. For example, the communication control unit 201 receives data (packets) from the terminal 10. The communication control unit 201 transmits data to the terminal 10. The communication control unit 201 passes the data received from another apparatus to another processing module. The communication control unit 201 transmits data acquired from another processing module to another apparatus. As described above, another processing module transmits and receives data to and from other apparatuses via the communication control unit 201.

The user registration unit 202 is a means for achieving the system user registration described above. The user registration unit 202 acquires profile information of each of a plurality of users using the online conference system.

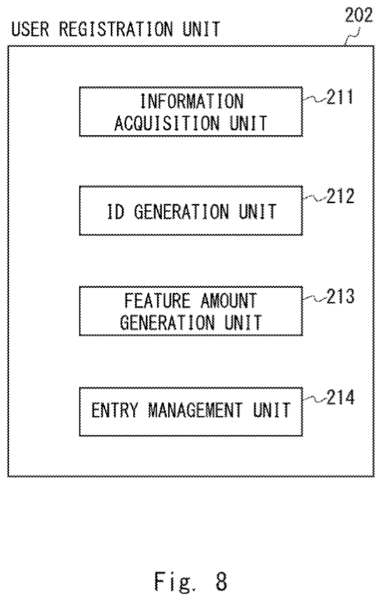

The user registration unit 202 includes a plurality of sub-modules. FIG. 8 is a diagram illustrating an example of a processing configuration of the user registration unit 202. Referring to FIG. 8, the user registration unit 202 includes an information acquisition unit 211, an ID generation unit 212, a feature amount generation unit 213, and an entry management unit 214.

The information acquisition unit 211 is a means for acquiring the profile information explained above. The information acquisition unit 211 acquires profile information including biometric information and attribute information of each system user. The system user may input the above information from the terminal 10 to the server apparatus 20, or may input the above information by directly operating the server apparatus 20.

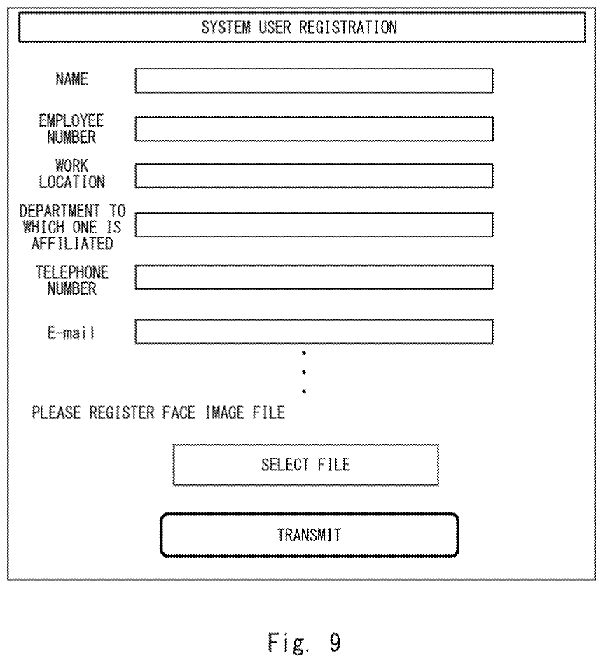

The information acquisition unit 211 may provide a graphical user interface (GUI) and a form for inputting the above information. For example, in response to the terminal 10 accessing the server apparatus 20, the information acquisition unit 211 displays an information input form as illustrated in FIG. 9 on the terminal 10 to be operated by the user.

The system user inputs the information illustrated in FIG. 9. After inputting each piece of information, the system user presses the “transmit” button and registers the biometric information and the attribute information in the server apparatus 20.

The information acquisition unit 211 stores the acquired profile information (biological information and attribute information) in the storage unit 205.

The ID generation unit 212 is a means for generating an ID to be assigned to a system user. The ID generation unit 212 generates a user ID for identifying each of a plurality of system users. For example, the ID generation unit 212 may calculate a hash value of the acquired profile information (face image, attribute information) and the hash value may be an ID to be assigned to the user. Alternatively, the ID generation unit 212 may assign a unique value to the ID every time the user is registered.

The feature amount generation unit 213 is a means for generating, from a face image of the profile information, a feature amount (a feature vector including a plurality of feature amounts) that characterizes the face image. Specifically, the feature amount generation unit 213 extracts a feature point from the acquired face image and generates a feature amount. Since an existing technique can be used for feature amount generation processing, a detailed explanation thereof will be omitted. For example, the feature amount generation unit 213 extracts an eye, a nose, a mouth, or the like from a face image as a feature point. Thereafter, the feature amount generation unit 213 calculates a position of each feature point and a distance between the feature points as feature amounts, and generates a feature vector including a plurality of feature amounts.

The entry management unit 214 is a means for managing entries in the user information database. When a new user is registered in the database, the entry management unit 214 adds an entry including the generated user ID, the generated feature amount, the face image, and the attribute information to the user information database.

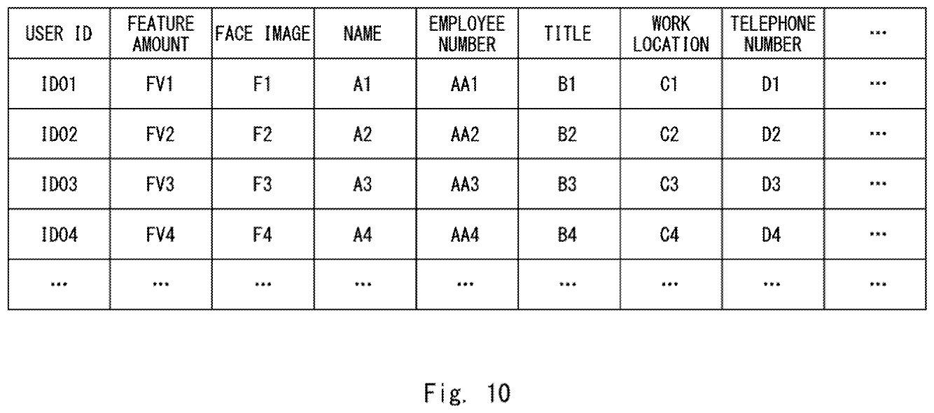

For example, the user registration unit 202 constructs a user information database as illustrated in FIG. 10. Note that contents registered in the user information database illustrated in FIG. 10 are examples, and it is needless to say that the contents is not intended to limit information to be registered in the user information database. For example, as necessary, the “feature amount” may not be registered in the user information database. When a face image is present, the feature amount can be calculated, and the feature amount may be calculated as necessary.

The explanation is returned to FIG. 7. The conference participation request processing unit 203 is a means for processing a conference participation request acquired from the terminal 10. The conference participation request processing unit 203 generates a list of conference participants (participants in the online conference among the users who has registered in the system). The conference participation request processing unit 203 receives “conference participation request” from the terminal 10 to be used by each participant at the start of the online conference. The conference participation request processing unit 203 extracts a face image acquired from the conference participation request, and generates a feature amount from the extracted face image.

The conference participation request processing unit 203 sets the feature amount generated based on the face image acquired from the terminal 10 as a collation target, and performs collation processing between feature amounts registered in the user information database. More specifically, the conference participation request processing unit 203 sets the calculated feature amount (feature vector) as a collation target, and executes a one-to-N(N is a positive integer, hereinafter the same) collation between a plurality of feature vectors being registered in the user information database.

The conference participation request processing unit 203 calculates a degree of similarity between the feature amount being the collation target and each of a plurality of feature amounts on the registration side. As the degree of similarity, a chi-square distance, a Euclidean distance, or the like can be used. The farther the distance is, the lower the degree of similarity is, and the closer the distance is, the higher the degree of similarity is.

The conference participation request processing unit 203 specifies a feature amount to which the degree of similarity of the feature amount being the collation target is equal to or greater than a predetermined value and the degree of similarity is the highest, among the plurality of feature amounts registered in the user information database.

The conference participation request processing unit 203 reads the user ID associated to the feature amount acquired as a result of the one-to-N collation from the user information database.

The conference participation request processing unit 203 repeats the above-described processing on the face image acquired from each of the terminals 10, and specifies the user ID associated to each face image. The conference participation request processing unit 203 generates a participant list by associating the specified user ID with the terminal ID of the terminal 10 that is a transmission source of the face image.

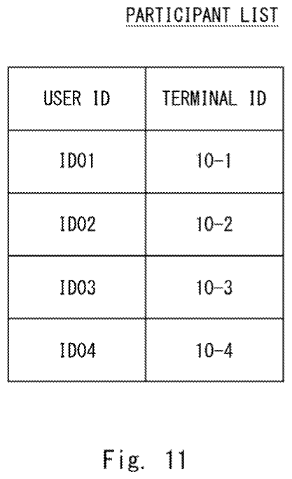

The terminal ID is included in the conference participation request transmitted from each terminal 10. For the terminal ID, a Media Access Control (MAC) address or an Internet Protocol (IP) address of the terminal 10 can be used. For example, in the example of FIG. 2, a participant list as illustrated in FIG. 11 is generated. In FIG. 11, for ease of understanding, a code given to the terminal 10 is described as a terminal ID.

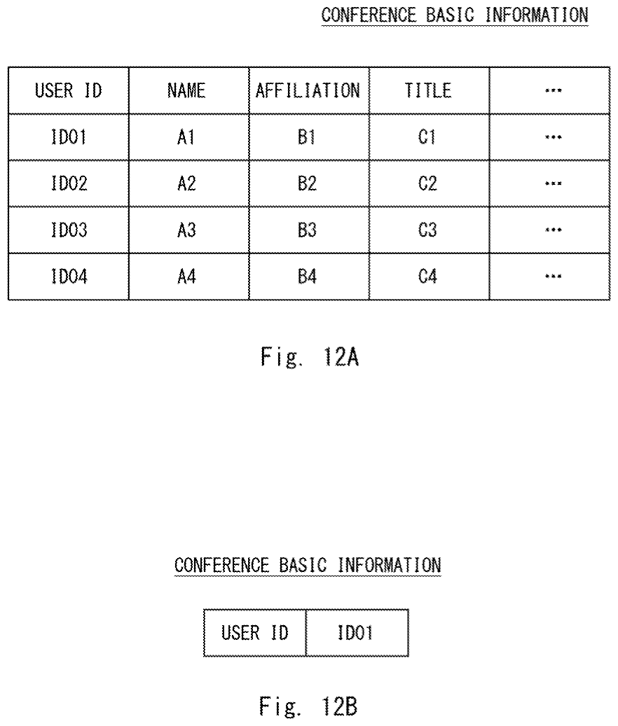

The conference participation request processing unit 203 generates conference basic information related to the online conference. The conference basic information includes the user ID of the conference participant and the participant basic information associated to each participant. The conference participation request processing unit 203 searches the user information database using the user ID of the participant list as a key, and specifies the associated entry. The conference participation request processing unit 203 reads out information to be transmitted as basic information from profile information of the specified entry. The conference participation request processing unit 203 transmits the conference basic information including a combination of the user ID and the basic information of the conference participant to each terminal 10. For example, in the example of FIG. 2, a combination as illustrated in FIG. 12A is transmitted to each terminal 10.

The conference participation request processing unit 203 transmits information enabling each terminal 10 to acquire an ID (hereinafter, referred to as a user ID) related to a user of the own apparatus while including the information in the conference basic information. For example, when the conference basic information is transmitted to the terminal 10-1 used by the user A1, the conference basic information including the information illustrated in FIG. 12B is transmitted to the terminal 10-1.

In the following explanation, the user ID other than a user of the terminal among the user IDs of the conference participants is referred to as “other-person ID”. In examples of FIGS. 12A and 12B, since “ID01” is the user ID, “ID02” to “ID04” are other person IDs.

When the conference participation request can be processed normally, the conference participation request processing unit 203 transmits the conference basic information to the terminal 10 as an acknowledgement. Note that the conference participation request processing unit 203 transmits a negative acknowledgement to the terminal 10 when the conference participation request cannot be processed normally (e.g., when collation of the acquired face image fails).

The conference participation request processing unit 203 transmits the conference basic information to the terminal 10 of the user who has already participated in the conference every time the participant list is generated (every time the user is permitted to participate in the conference).

As described above, the conference participation request processing unit 203 generates, from the profile information, the basic information of the participant participating in the online conference in response to the acquisition of the participation request to the online conference from the terminal 10 used by the participant participating in the online conference. At this time, the conference participation request processing unit 203 specifies the participant participating in the online conference by the collation processing using biological information stored in the storage unit 205 and biological information included in the conference participation request. The conference participation request processing unit 203 transmits the generated basic information to the terminal 10 used by the participant participating in the online conference.

The business card exchange control unit 204 is a means for controlling exchange of digital business cards by participants. The business card exchange control unit 204 achieves a digital business card for a first user (name exchange requester) and a second user (business card exchange request recipient) who participate in the same online conference among a plurality of users. The business card exchange control unit 204 generates the digital business cards of the business card exchange parties (the first and second users), based on profile information of each of the first and second users. The business card exchange control unit 204 exchanges digital business cards generated between the first and second users.

The business card exchange control unit 204 receives a digital business card exchange request related to business card exchange with the business card exchange request recipient from the terminal 10 used by the business card exchange requester. The business card exchange control unit 204 processes the digital business card exchange request. The business card exchange control unit 204 extracts the requester ID and the request recipient ID from the acquired digital business card exchange request.

The business card exchange control unit 204 refers to the participant list and specifies the terminal ID associated to the request recipient ID. The business card exchange control unit 204 transmits a digital business card exchange inquiry (inquiry regarding whether to accept a business card exchange with a business card requester) to the terminal 10 (the terminal 10 used by the business card exchange request recipient) associated to the specified terminal ID. At this time, the business card exchange control unit 204 transmits a digital business card exchange inquiry including the requester ID of the business card exchange requester to the terminal 10.

The business card exchange control unit 204 acquires a response (acknowledgement or negative acknowledgement) from the terminal 10 serving as a transmission destination of the digital business card exchange inquiry.

In a case where a negative acknowledgement (rejection of business card exchange by a business card exchange request recipient) is received from the terminal 10 of the business card exchange request recipient, the business card exchange control unit 204 transmits the fact to the terminal 10 of the business card exchange requester (the terminal 10 used by the digital business card exchange requester). In short, the business card exchange control unit 204 transmits (transfers) the negative acknowledgement to the terminal 10.

When an acknowledgement (acceptance of business card exchange by a business card exchange request recipient) is received from the terminal 10 of the business card exchange request recipient, the business card exchange control unit 204 generates a digital business card of each business card exchange party (business card exchange requester, business card exchange request recipient). Specifically, the business card exchange control unit 204 searches the user information database using the requester ID and the request recipient ID as keys, and specifies the associated entry.

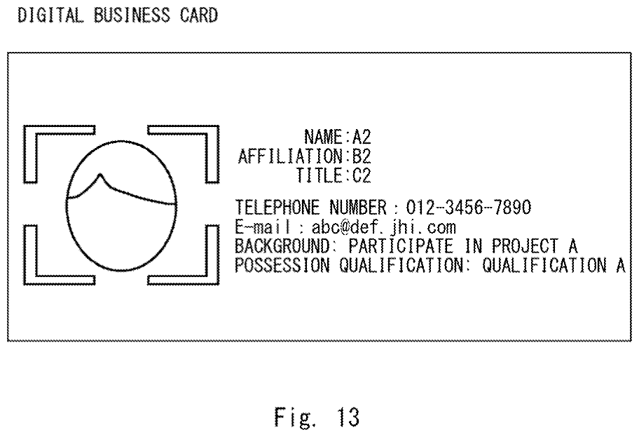

The business card exchange control unit 204 generates a digital business card of the business card exchange party by using information (biometric information and attribute information) acquired from the specified entry. Specifically, the business card exchange control unit 204 selects predetermined information from the information including the specified entry, and generates a digital business card. The business card exchange control unit 204 generates a digital business card by selecting a predetermined item from among a plurality of items included in the profile information. For example, the business card exchange control unit 204 generates a digital business card including information as illustrated in FIG. 13.

The business card exchange control unit 204 transmits the generated digital business card to the terminal 10 on the opposite side. The business card exchange control unit 204 transmits the digital business card of the business card exchange request recipient to the terminal 10 used by the business card exchange requester. The business card exchange control unit 204 transmits the digital business card of the business card exchange requester to the terminal 10 used by the business card exchange request recipient.

The storage unit 205 is a means for storing information necessary for an operation of the server apparatus 20. The storage unit 205 stores profile information (biometric information and attribute information) of each of a plurality of users.

### [Terminal]

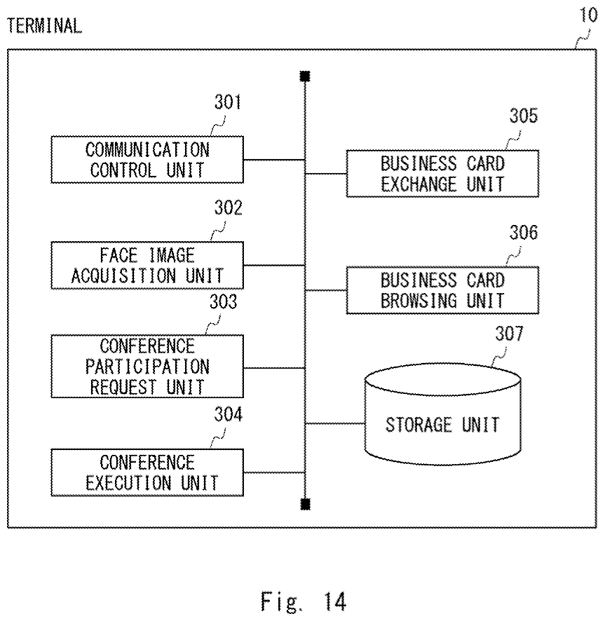

FIG. 14 is a diagram illustrating an example of a processing configuration (processing module) of the terminal 10. Referring to FIG. 14, the terminal 10 includes a communication control unit 301, a face image acquisition unit 302, a conference participation request unit 303, a conference execution unit 304, a business card exchange unit 305, a business card browsing unit 306, and a storage unit 307.

The communication control unit 301 is a means for controlling communication between other apparatuses. For example, the communication control unit 301 receives data (packets) from the server apparatus 20. The communication control unit 301 transmits data to the server apparatus 20. The communication control unit 301 passes data received from another apparatus to another processing module. The communication control unit 301 transmits data acquired from another processing module to another apparatus. As described above, another processing module transmits and receives data to and from other apparatuses via the communication control unit 301.

The face image acquisition unit 302 is a means for controlling a camera apparatus and acquiring a face image (biological information) of a user in front of the camera apparatus. At the start of the online conference (e.g., when an icon of application for the online conference is clicked), the face image acquisition unit 302 captures an image of the user. The face image acquisition unit 302 determines whether a face image of a person is included in the acquired image, and extracts a face image from the acquired image data when the face image is included. The face image acquisition unit 302 stores the extracted face image in the storage unit 307.

Note that face image detection processing and face image extraction processing by the face image acquisition unit 302 can be performed by using existing techniques, and thus detailed explanation thereof will be omitted. For example, the face image acquisition unit 302 may extract a face image (face area) from the image data by using a learning model learned by Convolutional Neural Network (CNN). Alternatively, the face image acquisition unit 302 may extract the face image by using a technique such as template matching.

The conference participation request unit 303 is a means for requesting the server apparatus 20 to participate in a conference. Specifically, the conference participation request unit 303 transmits “conference participation request” including the face image of the user and the terminal ID to the server apparatus 20. The conference participation request unit 303 transmits, as necessary, an ID for specifying a conference to be participated and a password for participating in the conference to the server apparatus 20.

When a negative acknowledgement (conference participation rejection) is received from the server apparatus 20, the conference participation request unit 303 notifies the user of this fact. When an acknowledgement (conference basic information) is received from the server apparatus 20, the conference participation request unit 303 passes the conference basic information to the conference execution unit 304.

The conference execution unit 304 is a means for achieving an online conference. The conference execution unit 304 transmits voice data acquired from a microphone to the server apparatus 20, and outputs the voice data acquired from the server apparatus 20 from a voice device such as a speaker or an earphone. In addition, the conference execution unit 304 displays image data (shared data and data related to the speaker) acquired from the server apparatus 20.

The conference execution unit 304 determines an ID (user ID) of a user who uses the own apparatus and IDs (other-person IDs) of other participants from the conference basic information acquired from the server apparatus 20 via the conference participation request unit 303. The conference execution unit 304 stores these IDs in the storage unit 307.

The conference execution unit 304 displays the basic information display area as illustrated in FIG. 3 by using the other-person IDs and participant basic information associated with the other-person IDs.

The business card exchange unit 305 is a means for achieving an online business card exchange. The business card exchange unit 305 is different between an operation when the business card exchange requester operates the terminal 10 and an operation when the non-business card exchange requester operates the terminal 10.

Hereinafter, each of the operations will be explained in order. In this case, a case where the user A1 desires to exchange a business card with the user A2 will be explained as in the above example. The user A1 is a business card exchange requester, and the terminal 10-1 is a use terminal of the user. In addition, the user A2 is a business card exchange request recipient, and the terminal 10-2 is a use terminal of the user.

<Case where the Business Card Exchange Requester Operates>

The terminal 10-1 of the user A1 performs the display as illustrated in FIG. 3. Since the user A1 desires to exchange a business card with the user A2, the user A1 presses the “business card exchange” button described in the uppermost row of the basic information display area.

When the button press is detected, the business card exchange unit 305 acquires the other-person ID of the user A2 from a position of the pressed button. Thereafter, the business card exchange unit 305 sets the user ID of the user A1 to the requester ID and the other-person ID of the user A2 to the request recipient ID, and generates a digital business card exchange request including these IDs. The business card exchange unit 305 transmits the generated digital business card exchange request to the server apparatus 20.

When the business card exchange request is rejected, the business card exchange unit 305 notifies the user of the fact. When the business card exchange request is accepted, the business card exchange unit 305 stores the digital business card of the business card exchange request recipient, which is acquired from the server apparatus 20, in the storage unit 307.

<Case where the Business Card Exchange Request Recipient Operates>

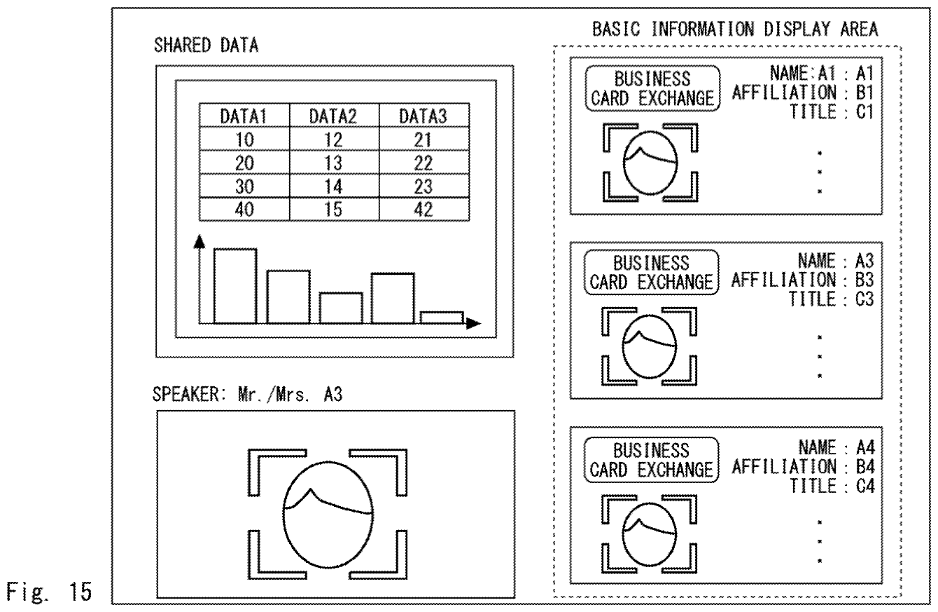

The terminal 10-2 operated by the user A2 who is a business card exchange request recipient performs display as illustrated in FIG. 15.

The business card exchange unit 305 acquires a digital business card exchange inquiry from the server apparatus 20. The business card exchange unit 305 retrieves the requester ID from the digital business card exchange inquiry, and specifies the other-person ID of the user who desires to exchange a business card. In the above example, since the user A1 desires to exchange a business card, the other-person ID of the user A1 is specified.

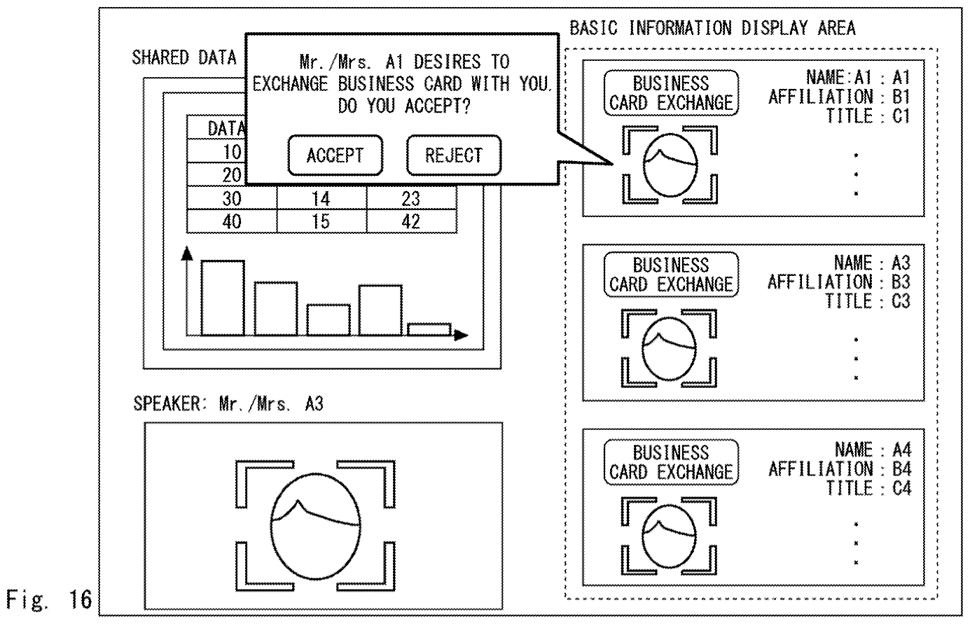

The business card exchange unit 305 notifies the user (user A2) that another participant (user A1) desires to exchange a business card. For example, the business card exchange unit 305 performs a display as illustrated in FIG. 16 and clearly indicates a business card exchange requester.

Further, as illustrated in FIG. 16, the business card exchange unit 305 displays a GUI for inputting whether to accept the requested business card exchange. When the user (user A2) accepts the business card exchange, the business card exchange unit 305 notifies the server apparatus 20 of the fact (transmits an acknowledgement). When the user rejects the business card exchange, the business card exchange unit 305 notifies the server apparatus 20 of the fact (transmits a negative acknowledgement).

When the business card exchange is accepted, the digital business card of the business card exchange requester is transmitted from the server apparatus 20, and thus the business card exchange unit 305 stores the received digital business card.

The business card exchange unit 305 included in the terminal 10 of the business card exchange party may display the digital business card received from the server apparatus 20. Specifically, the business card exchange unit 305 may perform display as illustrated in FIG. 13.

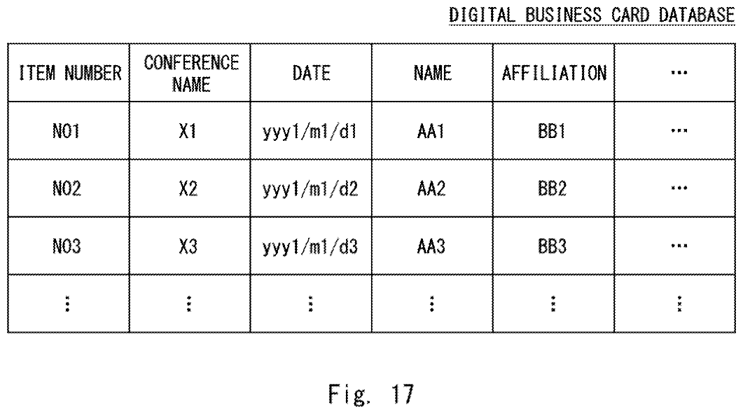

As described above, the business card exchange unit 305 stores the acquired digital business card in the storage unit 307. More specifically, the business card exchange unit 305 stores the digital business card in the digital business card database constructed in the storage unit 307. At this time, the business card exchange unit 305 stores information such as a situation when a digital business card is acquired and the acquired digital business card in association with each other. For example, the business card exchange unit 305 stores a conference name at the time of exchanging the digital business card, a conference holding date, and the acquired digital business card in association with each other (registered in the digital business card database; see FIG. 17). In FIG. 17, a name or the like is pertinent to an item described in a digital business card.

The business card browsing unit 306 is a means for enabling browsing of the digital business card stored in a digital business card database. The business card browsing unit 306 enables browsing of a digital business card stored in a digital business card database by using various methods.

For example, the business card browsing unit 306 may display a list of digital business cards (a list of thumbnails and icons) stored in the digital business card database. Alternatively, the business card browsing unit 306 may display the digital business cards one by one. In this case, the business card browsing unit 306 may display a button for cutting off the digital business card to be displayed.

The business card browsing unit 306 may search the digital business card database by using a keyword or a search condition being input by the user, and display the hit digital business card. The business card browsing unit 306 may perform a search based on a conference name, a conference holding date, and the like, in addition to items (a name, an affiliation, and the like) of the digital business card.

The storage unit 307 is a means for storing information necessary for the operation of the terminal 10.

### [Operation of Online Conference System]

Next, an operation of the online conference system according to the first example embodiment will be explained.

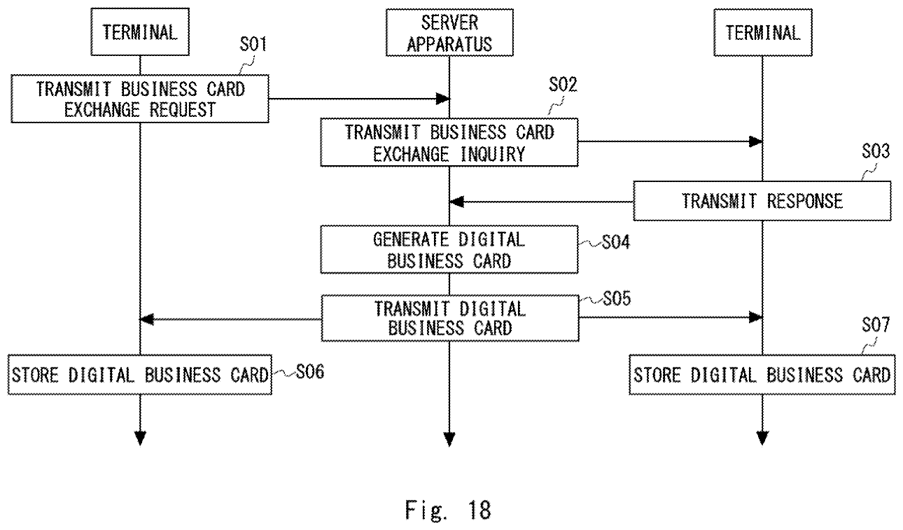

FIG. 18 is a sequence diagram illustrating an example of the operation of the online conference system according to the first example embodiment. With reference to FIG. 18, a system operation in a case where digital business cards are exchanged between participants will be explained. It is assumed that a system user is registered in advance prior to the operation of FIG. 18.

When the conference starts, the basic information of other participants is displayed on the screen (see FIGS. 3 and 15). The participant presses the “business card exchange” button of a participant who desires to exchange the business card. In response to the pressing of the button, the terminal 10 transmits a digital business card exchange request to the server apparatus 20 (step S01).

The server apparatus 20 specifies a business card exchange partner (business card exchange request recipient) from the digital business card exchange request, and transmits a digital business card exchange inquiry to the terminal 10 of the exchange partner (step S02).

The terminal 10 acquires an intention of the user regarding the business card exchange. For example, the terminal 10 acquires the intention of the user regarding the business card exchange by the GUI as illustrated in FIG. 16. Thereafter, the terminal 10 transmits the user's intention to the server apparatus (transmits a response; step S03).

When the acquired response is a negative acknowledgement (business card exchange rejection), the server apparatus 20 notifies the terminal 10 on a side of the business card exchange requester of this fact.

When the acquired response is an acknowledgement (business card exchange acceptance), the server apparatus 20 generates a digital business card of the business card exchange party (step S04).

The server apparatus 20 transmits the generated digital business card to the destination (step S05).

The terminal 10 of the business card exchange party stores the acquired digital business card in the digital business card database (steps S06 and S07).

As described above, in the online conference system according to the first example embodiment, the profile information of the conference participants is input in advance, and when an agreement of the party regarding the business card exchange is acquired, the digital business card is generated from the profile information acquired in advance. The generated digital business card is distributed to the business card exchange partner. As described above, the server apparatus 20 according to the first example embodiment enables business card exchange online.

### Second Example Embodiment

Next, a second example embodiment will be explained in detail with reference to the drawings.

In the first example embodiment, it is explained that the server apparatus 20 selects an item to be described in the digital business card from the pre-registered profile information and generates the digital business card. In the second example embodiment, another method for generating a digital business card will be explained.

Note that a configuration of an online conference system according to the second example embodiment can be the same as that of the first example embodiment, and thus explanation equivalent to FIG. 2 is omitted. In addition, since processing configurations of a terminal 10 and a server apparatus 20 according to the second example embodiment can be the same as those of the first example embodiment, the explanation thereof will be omitted. Hereinafter, differences between the first and second example embodiments will be mainly explained.

### <Register Digital Business Card in Advance>

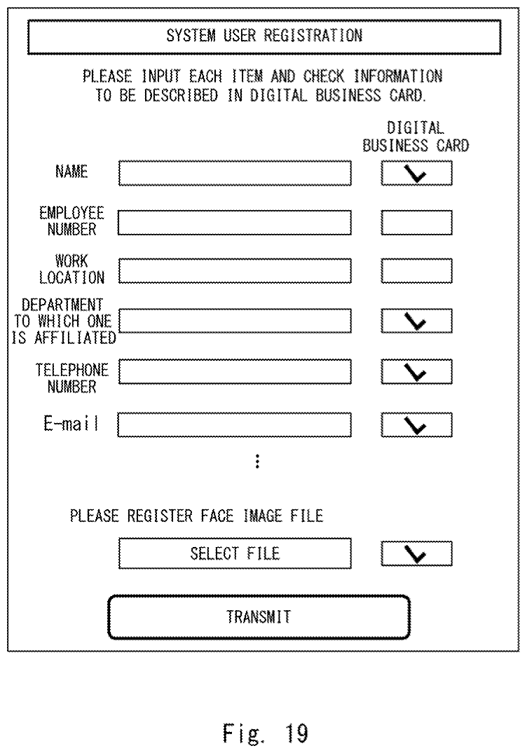

When registering a user, the user may input information to be provided to another person as a digital business card. In this case, a user registration unit 202 of the server apparatus 20 may generate a GUI as illustrated in FIG. 19 and allow the user to select information to be described in the digital business card.

A user information database of the server apparatus 20 stores whether each item being input as profile information can be described in a digital business card. The information acquisition unit 211 acquires items to be described in the digital business card among a plurality of items included in the profile information, and stores the items in the storage unit 205.

The business card exchange control unit 204 generates a digital business card by referring to information on whether description can be made to the digital business card stored in the user information database when generating the digital business card.

Alternatively, the server apparatus 20 may acquire the above information by using a GUI for inputting each piece of participant basic information and the information described in the digital business card.

As described above, each user registers the information to be described in the digital business card in advance in the server apparatus 20, whereby it is possible to generate the digital business card in accordance with the actual situation of each user. For example, it is possible to satisfy each request of a user who wants to actively appeal a possession qualification and a user who does not want to appeal that.

### <Enter Items to be Described for Each Digital Business Card Exchange>

The user may input information to be described in the digital business card to the server apparatus 20 each time the business card is exchanged. Namely, the terminal 10 may instruct the server apparatus 20 to specify the items to be described in the digital business card every time the business card is exchanged.

Specifically, when sending the digital business card exchange request, the business card exchange unit 305 of the terminal 10 of the business card exchange requester also transmits the information to be described in the digital business card to the server apparatus 20. In addition, the business card exchange unit 305 of the terminal 10 of the business card exchange request recipient transmits information to be described in the digital business card to the server apparatus 20 together with an acknowledgement to the digital business card exchange inquiry.

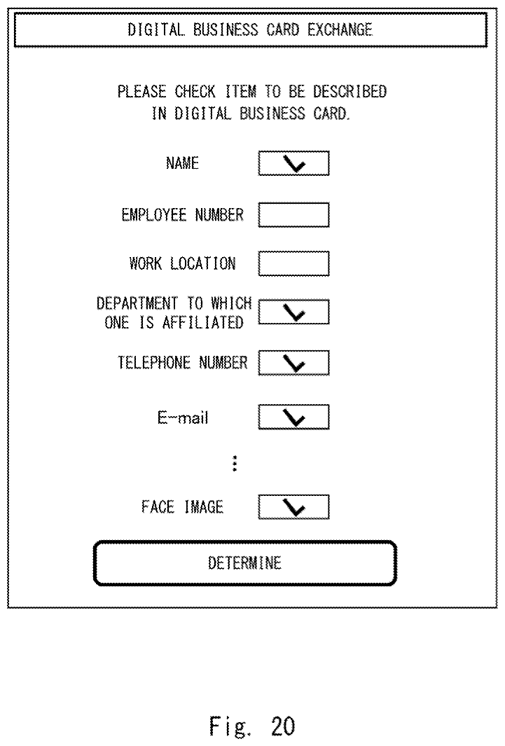

In this case, the terminal 10 on the business card exchange requester side may display the GUI as illustrated in FIG. 20 after the “business card exchange” button is pressed. In addition, the terminal 10 on a side of the business card exchange request recipient may display the GUI as illustrated in FIG. 20 after the business card exchange acceptance. The terminal 10 may transmit the information acquired by the GUI as illustrated in FIG. 20 to the server apparatus 20. A list of items that can be described in the digital business card may be transmitted from the server apparatus 20 to the terminal 10 at the time of pre-registration of the user or at the time of start of the conference.

The business card exchange control unit 204 of the server apparatus 20 generates a digital business card, based on information (information to be described in the digital business card) acquired from each of the two terminals 10. The business card exchange control unit 204 generates a digital business card by using an item designated by a business card exchange party (a business card exchange requester and/or a business card exchange request recipient) among a plurality of items included in the profile information.

As described above, by enabling the user to select a content to be described in the digital business card every time the digital business card is exchanged, the user can describe appropriate information in the digital business card according to the partner of the business card exchange. In other words, depending on the business card exchange partner, the user can provide detailed information or provide or select only the minimum necessary information.

### <Register Policy>

The server apparatus 20 may generate a digital business card, based on a policy (a policy related to a digital business card; a digital business card policy) being input by the user.

For example, the server apparatus 20 also acquires the above policy at the time of pre-registration of the user. The server apparatus 20 stores the digital business card policy in the user information database in association with the user ID.

Various contents of digital business card policies that can be set in the server apparatus 20 are conceivable.

For example, the user may input, to the server apparatus 20, a policy for determining the content to be described in the digital business card depending on an attribute of the business card exchange partner. For example, the user may change the content to be described in the digital business card between an external partner and an internal partner. For example, the server apparatus 20 stores a policy including an item to be described in a digital business card to be exchanged with an internal partner and an item to be described in a digital business card to be exchanged with an external partner in association with a user ID. In this case, the business card exchange control unit 204 of the server apparatus 20 may compare “companies” to which the business card exchange parties are affiliated and generate a digital business card according to the result.

Alternatively, the policy to be referred to by the server apparatus 20 may be registered to switch the content according to the person who is a providing (disclosure) destination of the digital business card. For example, a policy including an item to be disclosed to an employee of Company A, an item to be disclosed to an employee of Company B, and the like may be input to the server apparatus 20. In this case, the server apparatus 20 may refer to the company to which the business card exchange partner is affiliated, and when the company is described in the policy, may generate a digital business card according to contents thereof. In a case where the company to which the business card exchange partner is affiliated is not described in the policy, the server apparatus 20 may generate a default digital business card or respond in such a way as to inquire the user (terminal 10) of the content to be described in the digital business card.

Note that the user may register not only a policy related to generation of a digital business card but also a policy related to acceptance or rejection of a digital business card in the server apparatus 20. For example, a digital business card policy such as “allow all” or “reject all” may be registered in the server apparatus 20 in response to a request for exchange of a digital business card. In this case, the business card exchange control unit 204 of the server apparatus 20 refers to the policy, thereby enabling to determine whether it is necessary to generate the digital business card without transmitting the digital business card exchange inquiry to the terminal 10 by referring to the policy. Of course, the user can also set a policy such as “accept all business card exchange requests from within the company” or “reject all business card exchange requests from outside the company”.

As described above, in the online conference system according to the second example embodiment, the digital business card is generated by various methods. Therefore, it is possible to generate an appropriate digital business card satisfying user's request and intention.

### Third Example Embodiment

Next, a third example embodiment will be explained in detail with reference to the drawings.

In the first example embodiment, it is explained that the terminal 10 used by the user stores the digital business cards of other participants transmitted from the server apparatus 20 and enables the terminal user to browse the stored digital business cards. In the third example embodiment, a case where a digital business card acquired by a user is shared with another user will be explained. In the third example embodiment, a case will be explained where a digital business card acquired by an employee is shared with another employee belonging to the same company or the same department.

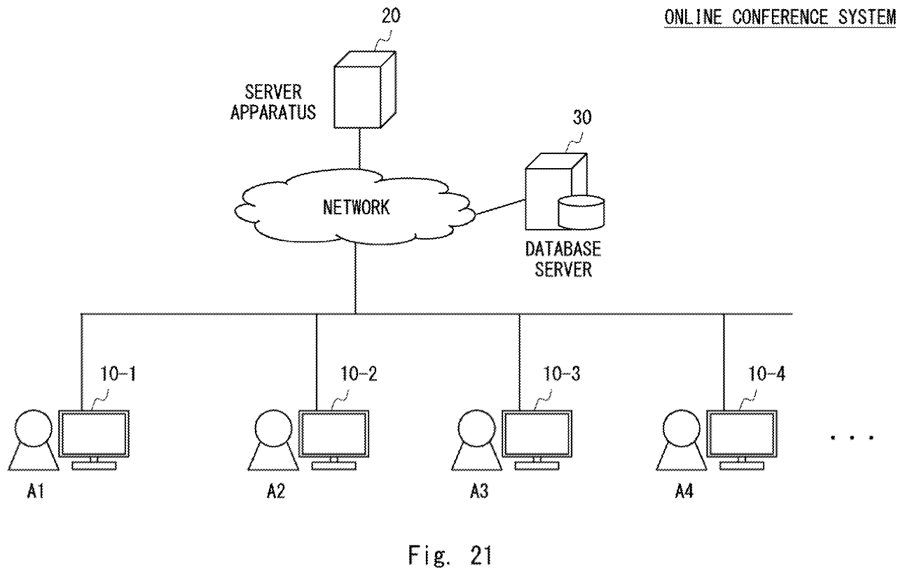

FIG. 21 is a diagram illustrating an example of an overview configuration of an online conference system according to the third example embodiment. As illustrated in FIG. 21, in the online conference system according to the third example embodiment, a database server 30 is added to the system according to the first example embodiment.

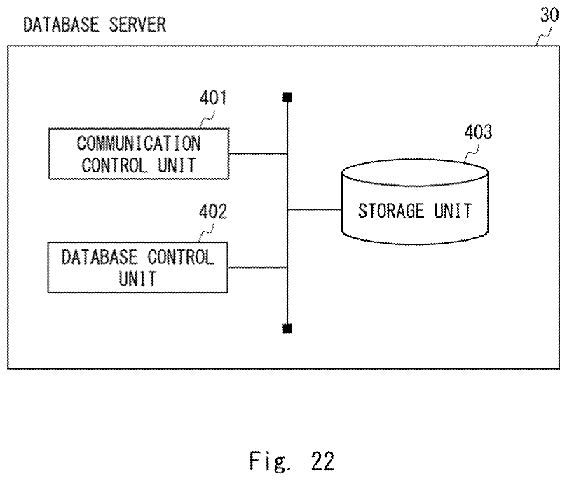

FIG. 22 is a diagram illustrating an example of a processing configuration (processing module) of the database server 30. Details of the modules constituting the database server 30 will be described later.

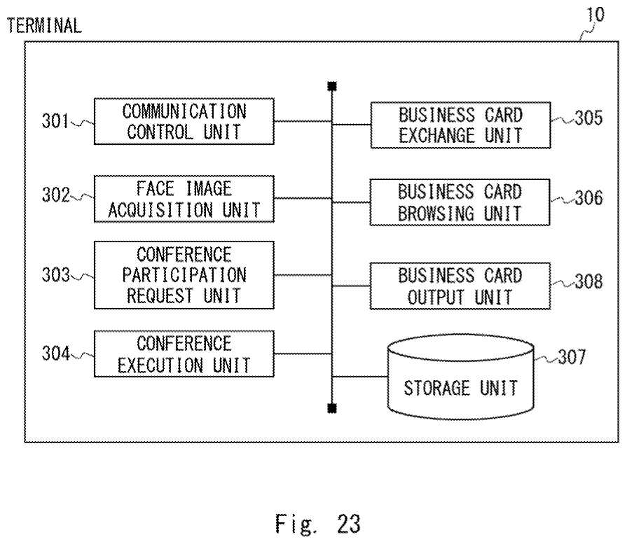

FIG. 23 is a diagram illustrating an example of a processing configuration (processing module) of a terminal 10 according to the third example embodiment. Referring to FIG. 23, a business card output unit 308 is added to the configuration of the terminal 10 according to the first and second example embodiments.

Since a processing configuration of a server apparatus 20 according to the third example embodiment can be the same as that of the first example embodiment, the explanation thereof will be omitted.

Hereinafter, differences between the first to third example embodiments will be mainly explained.

When the digital business card is acquired from the server apparatus 20, the business card exchange unit 305 passes the acquired digital business card to the business card output unit 308.

The business card output unit 308 is a means for outputting a digital business card to the database server 30. The business card output unit 308 transmits, to the database server 30, information at the time of acquiring the digital business card (a conference name, a conference holding date, and the like), information specifying an acquirer of the digital business card (a name, an employee number, and the like), and a digital business card.

Referring to FIG. 22, the database server 30 includes a communication control unit 401, a database control unit 402, and a storage unit 403.

The communication control unit 401 is a means for controlling communication with other apparatuses. For example, the communication control unit 401 receives data (packets) from the terminal 10. The communication control unit 401 transmits data to the terminal 10. The communication control unit 401 passes the data received from another apparatus to another processing module. The communication control unit 401 transmits data acquired from another processing module to another apparatus. As described above, another processing module transmits and receives data to and from other apparatuses via the communication control unit 401.

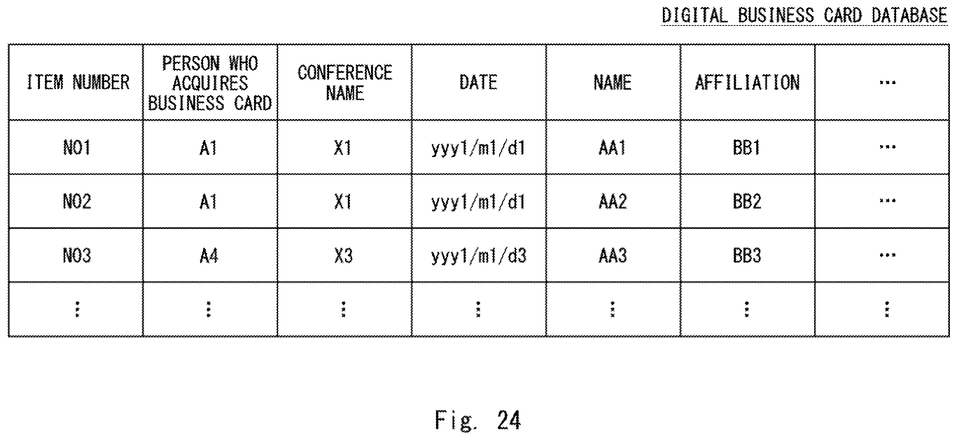

The database control unit 402 is a means for controlling the digital business card database constructed in the storage unit 403. When the digital business card or the like is acquired from the terminal 10, the database control unit 402 adds a new entry to the digital business card database and stores the acquired information (see FIG. 24).

Referring to FIG. 24, it can be seen that a user A1 acquires two digital business cards at a conference X1 and registers them in the database server 30. The digital business card databases illustrated in FIGS. 17 and 24 are examples, and are not intended to limit information, items, and the like to be stored. For example, more detailed content of the online conference (e.g., a name of an attendee, etc.) may be registered in the digital business card database. Namely, when the user exchanges the digital business card with a conference participant, information on the conference and the acquired digital business card are automatically associated with each other and registered in the digital business card database.

In addition, the user can refer to the digital business card stored in the database server 30. In this case, the business card browsing unit 306 of the terminal 10 transmits a digital business card browsing request (also simply referred to as a business card browsing request) to the database server 30.

The database control unit 402 processes the digital business card browsing request acquired from the terminal 10. For example, when a search keyword (e.g., a name, etc.) is included in the business card browsing request, the database control unit 402 searches the digital business card database by using the keyword and transmits the result to the terminal 10.

Alternatively, when a search condition (e.g., a business card acquisition period) is included in the business card browsing request, the database control unit 402 transmits the digital business card of the entry satisfying the search condition to the terminal 10.

The business card browsing unit 306 of the terminal 10 displays information (a response to a business card browsing request) acquired from the database server 30.

The storage unit 403 stores information necessary for the operation of the database server 30.

Note that the database server 30 that the terminal 10 transmits the digital business card and the like differs depending on attributes of each user (a company to which one is affiliated, a department to which one is affiliated, etc.). For example, when the user A1 and a user A2 belong to the same company, the terminals 10-1 and 10-2 transmit the digital business card to the database server managed by the company to which the two users belong. In other words, the database server 30 discards a digital business card acquired from a user (terminal 10) who is not authorized to register the digital business card in the database. In this case, the database server 30 may determine acceptance or rejection of the digital business card, based on the terminal ID (IP address, etc.) of the terminal 10.

In addition, the database server 30 rejects a business card browsing request from the terminal 10 that does not have a reference authority of the digital business card database. Also in this case, the database server 30 may determine whether to accept or reject the business card browsing request, based on the terminal ID (IP address, etc.) of the terminal 10.

As described above, the database server 30 according to the third example embodiment searches the digital business card database in response to reception of the digital business card browsing request, and transmits the search result to the terminal 10 that is a transmission source of the digital business card browsing request. In the online conference system according to the third example embodiment, digital business cards acquired by a colleague of a company or the like can be shared, and efficient economic activities and business activities can be performed. Namely, the digital business card acquired by the employee or the like may be managed not only by the terminal 10 owned by each employee but also by a company, a department, or the like as a unit. For example, when employees A and B are affiliated to the same department, digital business cards acquired by these employees are collectively managed by the department, and can be utilized by other employees. In addition, when the user uses a plurality of terminals 10 (e.g., a smartphone and a stationary personal computer), the user can also browse the digital business card acquired by one terminal 10 by another terminal 10.

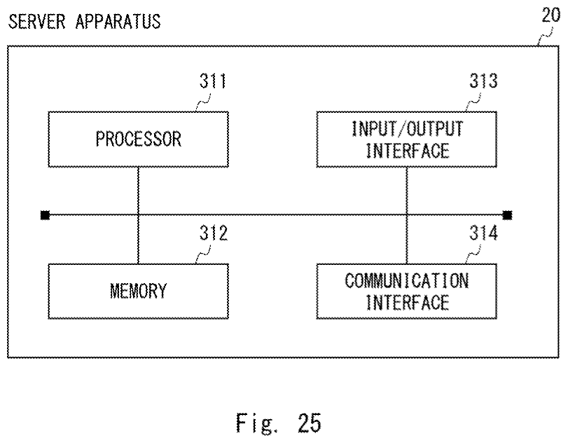

Next, hardware of each apparatus constituting the online conference system will be explained. FIG. 25 is a diagram illustrating an example of a hardware configuration of the server apparatus 20.

The server apparatus 20 can be configured by an information processing apparatus (so-called computer), and includes a configuration illustrated in FIG. 25. For example, the server apparatus 20 includes a processor 311, a memory 312, an input/output interface 313, a communication interface 314, and the like. The components such as the above processor 311 are connected by an internal bus or the like, and are configured to be able to communicate with each other.

However, the configuration illustrated in FIG. 25 is not intended to limit the hardware configuration of the server apparatus 20. The server apparatus 20 may include hardware that is not illustrated) or may not include the input/output interface 313 as necessary. Further, the number of processors 311 and the like included in the server apparatus 20 is not intended to be limited to the example illustrated in FIG. 25, and for example, a plurality of processors 311 may be included in the server apparatus 20.

The processor 311 is, for example, a programmable device such as a Central Processing Unit (CPU), a Micro Processing Unit (MPU), or a Digital Signal Processor (DSP). Alternatively, the processor 311 may be a device such as a Field Programmable Gate Array (FPGA), an Application Specific Integrated Circuit (ASIC), or the like. The processor 311 executes various programs including an operating system (OS).

The memory 312 is a Random Access Memory (RAM), a Read Only Memory (ROM), a Hard Disk Drive (HDD), a Solid State Drive (SSD), or the like. The memory 312 stores an OS program, an application program, and various data.

The input/output interface 313 is an interface of a display apparatus or an input apparatus that is not illustrated. The display apparatus is, for example, a liquid crystal display or the like. The input apparatus is, for example, an apparatus that receives a user operation such as a keyboard or a mouse.

The communication interface 314 is a circuit, a module, or the like that communicates with another apparatus. For example, the communication interface 314 includes Network Interface Card (NIC) and the like.

Functions of the server apparatus 20 are achieved by various processing modules. The processing module is achieved by, for example, the processor 311 executing a program stored in the memory 312. The program can be recorded in a computer readable storage medium. The storage medium may be non-transient (non-transitory) such as a semiconductor memory, a hard disk, a magnetic recording medium, or an optical recording medium. Namely, the present invention may be embodied as a computer program product. The program can be downloaded via a network or updated by using a storage medium storing the program. Further, the processing module may be achieved by a semiconductor chip.

Note that the terminal 10 and the database server 30 can also be configured by the information processing apparatus in the same manner as the server apparatus 20, and the basic hardware configuration thereof is not different from the server apparatus 20, and thus explanation thereof will be omitted. The terminal 10 may include a camera and a microphone, or may be configured to be connectable to a camera and a microphone.

The server apparatus 20 is mounted with a computer, and the function of the server apparatus 20 can be achieved by causing the computer to execute a program. In addition, the server apparatus 20 executes a business card exchange method by the program.

### Modified Example

Note that the configuration, operation, and the like of the online conference system explained in the above example embodiment are examples, and are not intended to limit the configuration and the like of the system.

The profile of the system user (attribute information of the user) may be input by using a scanner or the like. For example, the user inputs an image related to his/her own business card to the server apparatus 20 by using a scanner. The server apparatus 20 executes optical character recognition (OCR) processing on the acquired images. The server apparatus 20 may determine the profile of the user, based on the acquired information.

In the above example embodiment, a case has been explained in which biological information related to “face image” is transmitted from the terminal 10 to the server apparatus 20. However, biometric information related to a “feature amount generated from the face image” may be transmitted from the terminal 10 to the server apparatus 20. The server apparatus 20 may execute collation processing with respect to the feature amount registered in the user information database by using the acquired feature amount (feature vector).

As Zoom (registered trademark), when a participant desires to attend, an ID of the participant is transmitted, and when consent of a conference organizer (host) is acquired, the participant can participate in the conference (in addition to identification by biometric authentication).

In the above example embodiment, it has been explained that the conference participant is specified by the terminal 10 transmitting a conference participation request including the face image at the start of the conference. However, the participant may be specified by a user ID. Specifically, the server apparatus 20 may pay out a user ID generated at the time of system registration of the user to the terminal 10. The terminal 10 may transmit a conference participation request including the paid-out user ID to the server apparatus 20 in place of the face image. The server apparatus 20 can specify the user (conference participant) by the user ID. Alternatively, biometric authentication may be used when logging in to the terminal 10. In this case, the terminal 10 may transmit the conference participation request including the user ID paid out from the server apparatus 20 to the server apparatus 20 on condition that the biometric authentication is successful. Note that a timing at which the terminal 10 transmits the conference participation request may be a case in which an application for an online conference is started or a case in which a Uniform Resource Locator (URL) including information of an online conference is clicked.

In the above example embodiment, a case has been explained in which a single digital business card exchange request includes a single request recipient ID. However, one digital business card exchange request may include a plurality of request recipient IDs. In this case, the terminal 10 may prepare a GUI that enables selection of a plurality of business card exchange partners. The server apparatus 20 may retrieve a plurality of request recipient IDs from the digital business card exchange request and transmit a digital business card exchange inquiry to each of the associated terminals 10.

The terminal 10 and the database server 30 may store and manage not only digital business cards acquired online but also business cards acquired offline. The user may take in information described in a business card acquired by face-to-face with a scanner, and register the taken-in information in the terminal 10 or the database server 30.

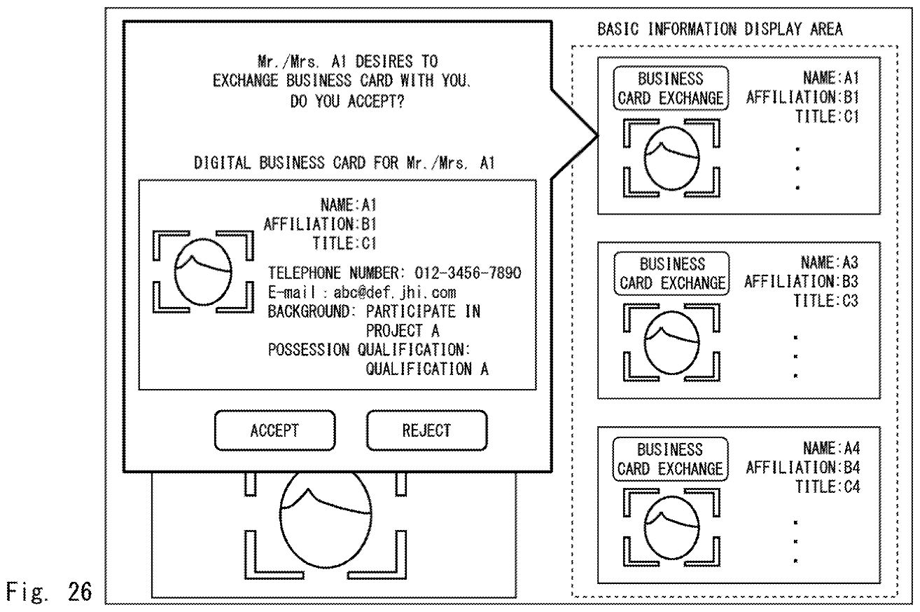

In the online conference system, an online business card of a business card exchange requester may be presented to a business card exchange request recipient, and the business card exchange request recipient may respond to business card exchange or determine items to be described in a digital business card according to contents of the presented online business card. For example, the server apparatus 20 acquires the information to be described in the digital business card of the business card exchange requester before the digital business card exchange inquiry by the method as explained in the second example embodiment. Thereafter, the server apparatus 20 generates a digital business card of the business card exchange requester, and transmits a digital business card exchange inquiry including the digital business card to the terminal 10 of the business card exchange request recipient. The terminal 10 may display the acquired digital business card on a screen for inputting whether the digital business card can be exchanged (see FIG. 26).

Alternatively, the terminal 10 of the business card exchange requester may select an item to be described in the digital business card instead of the digital business card itself and present the selected item to the terminal 10 of the business card exchange request recipient. In this case, the terminal 10 of the business card exchange request recipient may instruct the server apparatus 20 to generate a digital business card in which the same item as the presented item is described. Alternatively, the terminal 10 of the business card exchange request recipient is desired may generate a GUI for acquiring user's intention regarding whether to provide the same item as the presented item. In this case, when the user agrees to generate a digital business card of the same item as the presented item, the terminal 10 notifies the server apparatus 20 of the agreement. In addition, when the user does not agree to generate the digital business card, the terminal 10 may generate a GUI for inputting an item to be described in the digital business card.

Alternatively, the terminal 10 may select and disclose (present) a digital business card or an item to be described in a digital business card not only to the partner of the business card exchange but also to other participants. A user who contacts the presented content (a digital business card or an item described in a digital business card) can determine whether the user desires to exchange a digital business card with a user who presents the content.

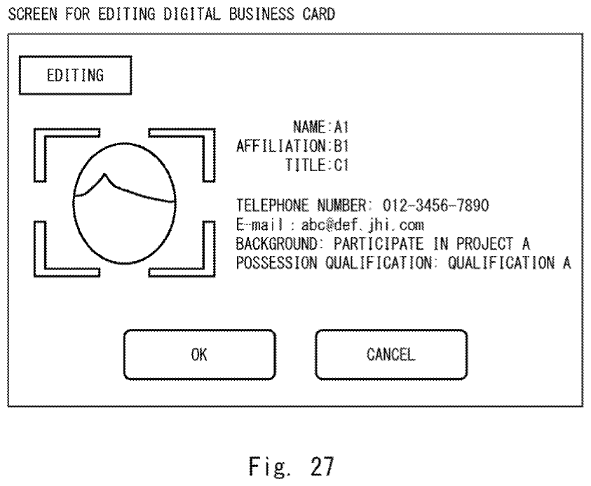

Alternatively, the terminal 10 may display a digital business card scheduled to be transmitted to the business card exchange partner, and generate a GUI that enables editing of the displayed digital business card (see FIG. 27). The terminal 10 transmits “registration data transmission request” including the user ID of the user to the server apparatus 20. The server apparatus 20 transmits the user's profile information to the terminal 10 in response to the request. The terminal 10 performs the display as illustrated in FIG. 27 by using the acquired profile information, and enables the user to edit the items to be described in the digital business card. The terminal 10 transmits the edited digital business card to the server apparatus 20 upon response to a digital business card exchange request or a digital business card exchange inquiry.

It may be requested to set a plurality of attribute values for the same item among the items included in the profile information. For example, when one user belongs to a company and a university, it is desired to register “company” and “university” as affiliation destinations. In order to respond to such a request, the server apparatus 20 may register attribute information such as “affiliation 1” and “affiliation 2”. Further, in this case, when a plurality of attribute values are set for the same item, the user (terminal 10) may input a policy or an instruction regarding which attribute value is to be described in the digital business card to the server apparatus 20. Alternatively, the attribute value to be described in the digital business card may be selected according to an account name when the user logs in to the terminal 10 or an account name when the user participates in the online conference.

When generating digital business cards of the business card exchange requester and the business card exchange request recipient, the server apparatus may generate the digital business cards by different methods. For example, the digital business card of the business card exchange requester may be generated based on an instruction from the requester, and the digital business card of the business card exchange request recipient may be generated based on the policy.

In the flowchart (flowchart, sequence diagram) used in the above explanation, a plurality of steps (processes) are described in order, but an execution order of the steps executed in the example embodiments is not limited to the order described. In the example embodiment, the order of the illustrated steps can be changed within a range that does not interfere with the contents, such as, for example, executing the respective processes in parallel.

The above-described example embodiments have been explained in detail in order to facilitate understanding of the present disclosure, and are not intended to require all the configurations explained above. When a plurality of example embodiments are explained, the example embodiments may be used alone or in combination. For example, a part of the configuration of the example embodiment may be replaced with the configuration of another example embodiment, or the configuration of another example embodiment may be added to the configuration of the example embodiment. Further, it is possible to add, delete, or replace a part of the configuration of the example embodiment with another configuration.

According to the above explanation, although the industrial applicability of the present invention is clear, the present invention can be suitably applied to an online conference system or the like to be performed by a company or the like.

Some or all of the above-described example embodiments may also be described as the following supplementary notes, but are not limited thereto.

### [Supplementary Note 1]

A server apparatus including:
an acquisition unit configured to acquire profile information of each of a plurality of users; and
a business card exchange control unit configured to generate a digital business card for a first user and a second user who participate in the same online conference among the plurality of users, based on profile information of each of the first and second users, and configured to exchange the generated digital business card between the first and second users.

### [Supplementary Note 2]

The server apparatus according to Supplementary note 1, wherein the business card exchange control unit receives a request relating to a business card exchange with the second user from a first terminal to be used by the first user, transmits an inquiry regarding whether to accept business card exchange with the first user, to a second terminal to be used by the second user, and, when a response of accepting business card exchange with the first user is received from the second terminal, generates a digital business card for each of the first and second users.

### [Supplementary Note 3]

The server apparatus according to Supplementary note 1 or 2, wherein
the profile information includes a plurality of items relating to an attribute of each user, and
the business card exchange control unit generates the digital business card by selecting a predetermined item from the plurality of items included in the profile information.

### [Supplementary Note 4]

The server apparatus according to Supplementary note 1 or 2, wherein
the profile information includes a plurality of items relating to an attribute of each user,
the acquisition unit acquires an item to be described in a digital business card among the plurality of items included in the profile information, and
the business card exchange control unit generates the digital business card by referring to an item to be described in the acquired digital business card.

### [Supplementary Note 5]

The server apparatus according to Supplementary note 1 or 2, wherein
the profile information includes a plurality of items relating to an attribute of each user, and
the business card exchange control unit generates the digital business card by using an item designated by the first and/or second user among the plurality of items included in the profile information.

### [Supplementary Note 6]

The server apparatus according to Supplementary note 1 or 2, wherein
the acquisition unit acquires a policy relating to a digital business card for each of the plurality of users, and
the business card exchange control unit generates the digital business card, based on the policy relating to the digital business card.

### [Supplementary Note 7]

The server apparatus according to any one of Supplementary notes 1 to 6, further including a conference participation request processing unit configured to generate basic information of a participant participating in the online conference from the profile information of the participant, in response to acquiring a conference participation request to the online conference from a terminal to be used by the participant participating in the online conference, and configured to transmit the generated basic information to a terminal to be used by the participant participating in the online conference.

### [Supplementary Note 8]

The server apparatus according to Supplementary note 7, wherein the acquisition unit acquires biometric information of each of the plurality of users,
the conference participation request includes biometric information of a user who desires to participate in the online conference, and
the conference participation request processing unit specifies the participant participating in the online conference by collation processing using
the acquired biometric information and biometric information included in the conference participation request.

### [Supplementary Note 9]

The server apparatus according to Supplementary note 7 or 8, wherein the digital business card includes more information than the basic information.

### [Supplementary Note 10]

An online conference system including:
a first terminal to be used by a first user;
a second terminal to be used by a second user; and
a server apparatus connected to the first and second terminals, wherein
the server apparatus includes an acquisition unit configured to acquire profile information of each of a plurality of users, and a business card exchange control unit configured to generate a digital business card for the first user and the second user who participate in the same online conference among the plurality of users, based on profile information of each of the first and second users and configured to transmit a digital business card for the first user to the second terminal and transmits a digital business card for the second user to the first terminal.

### [Supplementary Note 11]

The online conference system according to Supplementary note 10, wherein the first terminal stores the transmitted digital business card for the second user and allows the first user to browse the stored digital business card.

### [Supplementary Note 12]

The online conference system according to Supplementary note 10 or 11, further including a database server connected to the first and second terminals, wherein
the first and second terminals transmit the received digital business card to the database server,
the database server stores a digital business card for the first user and a digital business card for the second user in a digital business card database,
the first or second terminal transmits a digital business card browsing request to the database server, and
the database server searches the digital business card database in response to receiving the digital business card browsing request and transmits a search result to a transmission source of the digital business card browsing request.

### [Supplementary Note 13]

A business card exchange method including, by a server apparatus:
acquiring profile information of each of a plurality of users;
generating a digital business card for a first user and a second user who participate in the same online conference among the plurality of users, based on profile information of each of the first and second users; and
exchanging the generated digital business card between the first and second users.

### [Supplementary Note 14]

A computer readable storage medium storing a program for causing a computer mounted on a server apparatus to execute:
processing of acquiring profile information of each of a plurality of users;
processing of generating a digital business card for a first user and a second user who participate in the same online conference among the plurality of users, based on profile information of each of the first and second users; and
processing of exchanging the generated digital business card between the first and second users.

The disclosures of the cited prior art documents are incorporated herein by reference. Although the example embodiments of the present invention have been explained above, the present invention is not limited to these example embodiments. It will be understood by those skilled in the art that these example embodiments are illustrative only and that various modifications can be made without departing from the scope and spirit of the present invention. Namely, it is needless to say that the present invention includes various modifications and corrections that can be made by those skilled in the art according to the entire disclosure including the claims and the technical idea.

### REFERENCE SIGNS LIST

10, 10-1 to 10-4 TERMINAL
20 SERVER APPARATUS
20 DATABASE SERVER
101 ACQUISITION UNIT
102, 204 BUSINESS CARD EXCHANGE CONTROL UNIT
201, 301, 401 COMMUNICATION CONTROL UNIT
202 USER REGISTRATION UNIT
203 CONFERENCE PARTICIPATION REQUEST PROCESSING UNIT
205, 307, 403 STORAGE UNIT
211 INFORMATION ACQUISITION UNIT
212 ID GENERATION UNIT
213 FEATURE AMOUNT GENERATION UNIT
214 ENTRY MANAGEMENT UNIT
302 FACE IMAGE ACQUISITION UNIT
303 CONFERENCE PARTICIPATION REQUEST UNIT
304 CONFERENCE EXECUTION UNIT
305 BUSINESS CARD EXCHANGE UNIT
306 BUSINESS CARD BROWSING UNIT
308 BUSINESS CARD OUTPUT UNIT
311 PROCESSOR
312 MEMORY
313 INPUT/OUTPUT INTERFACE
314 COMMUNICATION INTERFACE
402 DATABASE CONTROL UNIT

What is claimed is:

1. A server apparatus comprising:
at least one memory storing instructions, and
at least one processor configured to execute the instructions to;
acquire profile information of each of a plurality of users; and
generate a digital business card for a first user and a second user who participate in the same online conference among the plurality of users, based on profile information of each of the first and second users, and
exchange the generated digital business card between the first and second users.

2. The server apparatus according to claim 1, wherein the at least one processor is configured to receive a request for exchanging a business card with the second user from a first terminal to be used by the first user,
transmit an inquiry regarding whether to accept business card exchange with the first user, to a second terminal to be used by the second user, and, when a response of accepting business card exchange with the first user is received from the second terminal, and
generate a digital business card for each of the first and second users.

3. The server apparatus according to claim 1, wherein
the profile information includes a plurality of items relating to an attribute of each user, and
the at least one processor is configured to generate the digital business card by selecting a predetermined item from the plurality of items included in the profile information.

4. The server apparatus according to claim 1, wherein
the profile information includes a plurality of items relating to an attribute of each user,
the at least one processor is configured to acquire an item to be described in a digital business card among the plurality of items included in the profile information, and
generate the digital business card by referring to an item to be described in the acquired digital business card.

5. The server apparatus according to claim 1, wherein
the profile information includes a plurality of items relating to an attribute of each user, and
the at least one processor is configured to generate the digital business card by using an item designated by the first and/or second user among the plurality of items included in the profile information.

6. The server apparatus according to claim 1, wherein
the at least one processor is configured to
acquire a policy relating to a digital business card for each of the plurality of users, and
generate the digital business card, based on the policy relating to the digital business card.

7. The server apparatus according to claim 1, the at least one processor is further configured to generate basic information of a participant participating in the online conference from the profile information of the participant, in response to acquiring a conference participation request to the online conference from a terminal to be used by the participant participating in the online conference, and configured to transmit the generated basic information to a terminal to be used by the participant participating in the online conference.

8. The server apparatus according to claim 7, wherein
the at least one processor is configured to acquire biological information of each of the plurality of users,
the conference participation request includes biological information of a user who desires to participate in the online conference, and
the at least one processor is configured to specify the participant participating in the online conference by collation processing using the acquired biological information and biological information included in the conference participation request.

9. The server apparatus according to claim 7, wherein the digital business card includes more information than the basic information.

10. An online conference system comprising:
a first terminal to be used by a first user;
a second terminal to be used by a second user; and
a server apparatus connected to the first and second terminals,
wherein the server apparatus includes
at least one memory storing instructions, and
at least one processor configured to execute the instructions to;
acquire profile information of each of a plurality of users, and
generate a digital business card for the first user and the second user who participate in the same online conference among the plurality of users, based on profile information of each of the first and second users and
transmit a digital business card for the first user to the second terminal and
transmit a digital business card for the second user to the first terminal.

11. The online conference system according to claim 10, wherein the first terminal stores the transmitted digital business card for the second user and allows the first user to browse the stored digital business card.

12. The online conference system according to claim 10, further comprising a database server connected to the first and second terminals, wherein
the first and second terminals transmit the received digital business card to the database server,
the database server stores a digital business card for the first user and a digital business card for the second user in a digital business card database,
the first or second terminal transmits a digital business card browsing request to the database server, and
the database server searches the digital business card database and transmits a search result to a transmission source of the digital business card browsing request, in response to receiving the digital business card browsing request.

13. A business card exchange method comprising, by a server apparatus:
acquiring profile information of each of a plurality of users;
generating a digital business card for a first user and a second user who participate in the same online conference among the plurality of users, based on profile information of each of the first and second users; and
exchanging the generated digital business card between the first and second users.

14. A non-transitory computer readable medium storing a program for causing a computer mounted on a server apparatus to execute:
processing of acquiring profile information of each of a plurality of users;
processing of generating a digital business card for a first user and a second user who participate in the same online conference among the plurality of users, based on profile information of each of the first and second users; and
processing of exchanging the generated digital business card between the first and second users.
